(19) United States
(12) Patent Application Publication
(10) Pub. No.: US 2023/0308418 A1
(43) Pub. Date: Sep. 28, 2023

(54) COMMUNICATION NETWORK SYSTEM, MANAGEMENT APPARATUS, SERVER APPARATUS, WHITELIST UPDATING METHOD AND PROGRAM

(71) Applicant: NIPPON TELEGRAPH AND TELEPHONE CORPORATION, Tokyo (JP)

(72) Inventors: Takahiro NUKUSHINA, Musashino-shi, Tokyo (JP); Iifan TYOU, Musashino-shi, Tokyo (JP); Yukio NAGAFUCHI, Musashino-shi, Tokyo (JP); Takaaki KOYAMA, Musashino-shi, Tokyo (JP)

(73) Assignee: NIPPON TELEGRAPH AND TELEPHONE CORPORATION, Tokyo (JP)

(21) Appl. No.: 18/018,581

(22) PCT Filed: Aug. 27, 2020
(86) PCT No.: PCT/JP2020/032490

§ 371 Date: Jan. 30, 2023

(51) Int. Cl. H04L 9/40

(52) U.S. Cl. CPC H04L 63/0263; H04L 63/20; H04L 63/10

(57) ABSTRACT

In a communication network system (1), each of a plurality of management devices (20) generates an individual whitelist, which is individually generated in each of a plurality of management devices (20), and is related to a communication destination of an IoT device (30A) connected to an own management device, and uploads a generated individual whitelist to a server device (10), the server device collects the plurality of individual whitelists uploaded from each of the plurality of management devices (20), generates an aggregated whitelist that is an aggregated result of the plurality of individual whitelists, and distributes the generated aggregated whitelist to each of the plurality of management devices (20), and each of the plurality of management devices (20) acquires the aggregated whitelist distributed from the server device (10), and updates the individual whitelist generated by an own management device based on the aggregated whitelist.

### TECHNICAL FIELD

The present disclosure relates to a communication network system, a management device, a server device, a whitelist update method, and a program.

### BACKGROUND ART

It is known that IoT (Internet of Things) devices often communicate with a specific communication pattern. Therefore, authorized communication destinations in IoT devices are learned as a whitelist (hereinafter referred to as “WL”), and communication destinations not included in the whitelist are regarded as an unauthorized communication destination, and it is possible to detect communication with an unauthorized communication destination (hereafter referred to as an “unauthorized communication”) by considering destinations not included in the whitelist as an unauthorized communication destination. The unauthorized communication may occur due to malware infection in IoT devices.

Therefore, there is a technique for generating a whitelist for each IoT device by learning an authorized communication destination for each IoT device by a gateway device connected to the IoT device.

### CITATION LIST

### Patent Literature

[PTL 1] Japanese Patent Application Publication No. 2019-213103

### SUMMARY OF INVENTION

### Technical Problem

However, when the communication cycle of the IoT device is longer than the learning period of the whitelist, it is difficult to observe all the communication destinations during the learning period, so that the validity of the whitelist is lowered.

In addition, since it takes some time for the number of communication destinations to stabilize after the whitelist learning is completed, the communication destinations of the IoT devices are added or changed by updating the firmware of the IoT devices after the whitelist learning is completed, or even if it is deleted, the validity of the whitelist will be reduced.

Therefore, in this disclosure, we propose a technique that can enhance the validity of the whitelist.

### Solution to Problem

The communication network system of the present disclosure comprises a server device and a plurality of management devices connected to each of a plurality of IoT devices. Each of the plurality of management devices generates the individual whitelist, which is individually generated in each of the plurality of management devices, and is related to a communication destination of an IoT device connected to an own management device, and uploads the generated individual whitelist to the server device. The server device collects the plurality of individual whitelists uploaded from each of the plurality of management devices, generates an aggregated whitelist that is an aggregated result of the plurality of individual whitelists, and distributes the generated aggregated whitelist to each of the plurality of management devices. Then, each of the plurality of management devices acquires the aggregated whitelist distributed from the server device, and updates the individual whitelist generated by an own management device based on the aggregated whitelist.

### Advantageous Effects of Invention

According to the disclosed technique, the validity of the whitelist can be enhanced.

### BRIEF DESCRIPTION OF DRAWINGS

FIG. 1 is a diagram showing a configuration example of the communication network system according to the embodiment 1 of the present disclosure.

FIG. 2 is a block diagram showing the configuration of the server device according to the embodiment 1 of the present disclosure.

FIG. 3 is a diagram showing a configuration example of the management device according to the embodiment 1 of the present disclosure.

FIG. 4 is a diagram for explaining an operation example of the communication network system according to the embodiment 1 of the present disclosure.

FIG. 5 is a diagram for explaining an operation example of the communication network system according to the embodiment 1 of the present disclosure.

FIG. 6 is a diagram for explaining an operation example of the communication network system according to the embodiment 1 of the present disclosure.

FIG. 7 is a diagram for explaining an operation example of the communication network system according to the embodiment 1 of the present disclosure.

FIG. 8 is a diagram for explaining an operation example of the communication network system according to the embodiment 1 of the present disclosure.

FIG. 9 is a diagram for explaining an operation example of the communication network system according to the embodiment 1 of the present disclosure.

FIG. 10 is a diagram for explaining an operation example of the communication network system according to the embodiment 1 of the present disclosure.

FIG. 11 is a diagram for explaining an operation example of the communication network system according to the embodiment 1 of the present disclosure.

FIG. 12 is a diagram for explaining an operation example of the communication network system according to the embodiment 1 of the present disclosure.

FIG. 13 is a diagram for explaining an operation example of the communication network system according to the embodiment 1 of the present disclosure.

FIG. 14 is a diagram for explaining an operation example of the communication network system according to the embodiment 1 of the present disclosure.

FIG. 15 is a diagram for explaining an operation example of the communication network system according to the embodiment 2 of the present disclosure.

FIG. 16 is a diagram for explaining an operation example of the communication network system according to the embodiment 2 of the present disclosure.

FIG. 17 is a diagram for explaining an operation example of the communication network system according to the embodiment 3 of the present disclosure.

FIG. 18 is a diagram for explaining an operation example of the communication network system according to the embodiment 3 of the present disclosure.

FIG. 19 is a diagram for explaining an operation example of the communication network system according to the embodiment 4 of the present disclosure.

FIG. 20 is a diagram for explaining an operation example of the communication network system according to the embodiment 4 of the present disclosure.

FIG. 21 is a diagram for explaining an operation example of the communication network system according to the embodiment 5 of the present disclosure.

FIG. 22 is a diagram for explaining an operation example of the communication network system according to the embodiment 5 of the present disclosure.

FIG. 23 is a diagram for explaining an operation example of the communication network system according to the embodiment 5 of the present disclosure.

FIG. 24 is a flowchart showing an example of the processing procedure in the communication network system according to the embodiment 6 of the present disclosure.

### DESCRIPTION OF EMBODIMENTS

Hereinafter, embodiments of the present disclosure will be described with reference to the drawings. In the following embodiments, the steps having the same configuration and the same processing are designated by the same reference signs.

### Embodiment 1

<Configuration of Communication Network System>

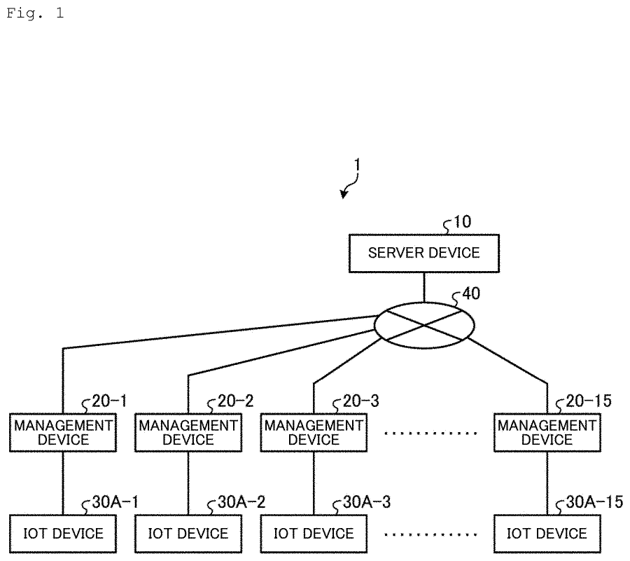

FIG. 1 is a diagram showing a configuration example of the communication network system of the embodiment 1 of the present disclosure. In FIG. 1, the communication network system 1 includes a server device 10, 15 management devices of management devices 20-1 to 2015, 15 IoT devices of IoT devices 30A-1 to 30A-15, and a network 40.

Each of IoT devices 30A-1 to 30A-5 is respectively connected to each of the management devices 20-1 to 20-5 one by one. The IoT devices 30A-1 to 30A-15 are IoT devices of the same model. In the following, the management devices 20-1 to 20-5 may be collectively referred to as “management device 20”, and the IoT devices 30A-1 to 30A-15 may be collectively referred to as “IoT device 30A”. The management device 20 and the server device 10 are connected to each other via the network 40. The IoT device 30A is a device in which a communication function is added to a device used for exclusive purpose, and an example of the IoT device 30A is a device in which a communication function is added to various devices such as a sensor and a surveillance camera. The IoT device 30A communicates with the communication destination via the management device 20. As an example of the management device 20, an example is a gateway device for connecting the IoT device 30A and the network 40. The Internet is an example of the network 40.

<Configuration of Server Device>

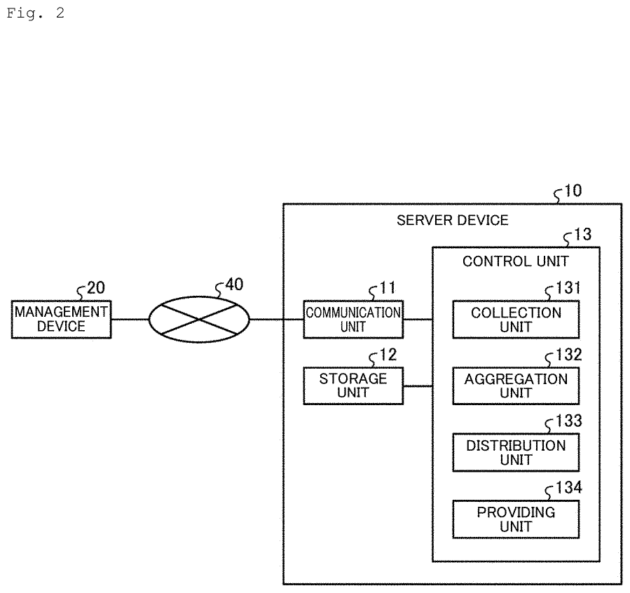

FIG. 2 is a diagram showing a configuration example of the server device according to the embodiment 1 of the present disclosure. In FIG. 2, the server device 10 has a communication unit 11, a storage unit 12, and a control unit 13. The control unit 13 has a collection unit 131, an aggregation unit 132, a distribution unit 133, and a providing unit 134. The communication unit 11 mutually communicates with the management device 20 via the network 40.

The control unit 13 is realized as hardware, for example, by a processor. Examples of the processor that realizes the control unit 13 include a CPU (Central Processing Unit), a DSP (Digital Signal Processor), an FPGA (Field Programmable Gate Array), and the like. Further, the storage unit 12 is realized as hardware, for example, by a storage medium. Examples of storage media that realize the storage unit 12 include memory, HDD (Hard Disk Drive), SSD (Solid State Drive), and examples of memory include RAM (Random Access Memory) and SDRAM (Synchronous Dynamic Random Access Memory), flash memory, and the like. The communication unit 11 is realized as hardware, for example, by a communication module.

<Structure of Management Device>

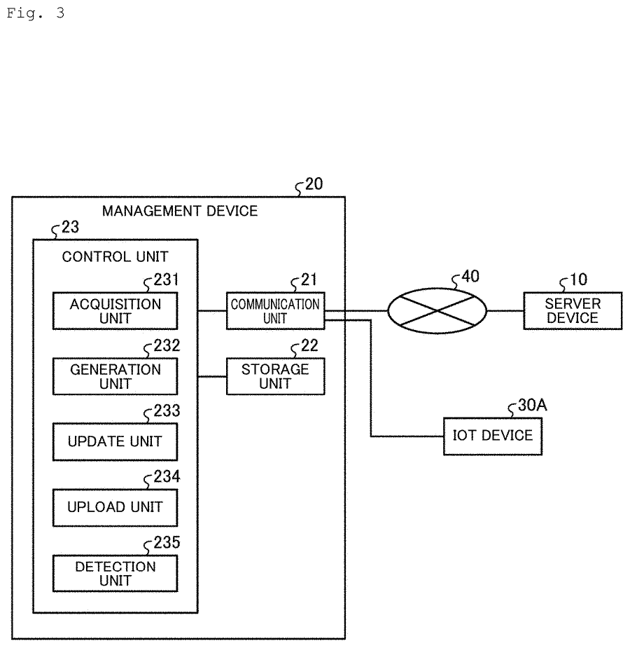

FIG. 3 is a diagram showing a configuration example of the management device according to the embodiment 1 of the present disclosure. In FIG. 3, the management device 20 has a communication unit 21, a storage unit 22, and a control unit 23. The control unit 23 includes an acquisition unit 231, a generation unit 232, an update unit 233, an upload unit 234, and a detection unit 235. The communication unit 21 mutually communicates with the server device 10 via the network 40. Further, the IoT device 30A is connected to the communication unit 21, and the communication unit 21 mutually communicates with the IoT device 30A.

The control unit 23 is realized as hardware, for example, by a processor. Examples of the processor that realizes the control unit 23 include a CPU, DSP, FPGA, and the like. Further, the storage unit 22 is realized as hardware, for example, by a storage medium. An example of a storage medium that realizes the storage unit 22 includes a memory, an HDD, an SSD, and the like, further an example of the memory includes a RAM, an SDRAM, a flash memory, and the like. The communication unit 21 is realized as hardware, for example, by a communication module.

<Operation of Communication Network System>

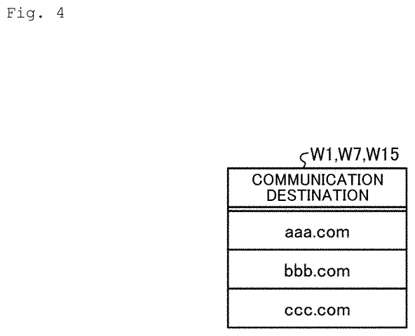

FIGS. 4 to 14 are diagrams provided for explaining an operation example of the communication network system according to the embodiment 1 of the present disclosure.

In the management device 20 (FIG. 3), the generation unit 232 collects information related to the communication of the IoT device 30A and learns the collected information in order for the detection unit 235 to detect the unauthorized communication in the IoT device 30A, and generates a whitelist showing authorized communication destinations in the IoT device 30A. The whitelist generated by the generation unit 232 is individually generated for each management device 20 in each of the management devices 20-1 to 20-15. For example, the generation unit 232 of the management device 20-1 generates a whitelist regarding the communication destination of the IoT device 30A-1 connected to the management device 20-1, and the generation unit 232 of the management device 20-2 is the management device, and generate a whitelist of communication destinations of the IoT device 30A-2 connected to 20-2. In the following, the whitelist generated for each management device 20 individually in each of the management devices 20-1 to 20-15 may be referred to as an “individual whitelist”. In the following, the individual whitelists generated in each of the management devices of 20-1, 20-2, 20-3, 20-4, 20-5, 20-6, 20-7, 20-8, 20-9, 20-10, 20-11, 20-12, 20-13, 20-14, and 20-15 may be written as “W1”, “W2”, “W3”, “W4”, “W5”, “W6”, “W7”, “W8”, “W9”, “W10”, “W11”, “W12”, “W13”, “W14”, and “W15”, respectively. The individual whitelists W1 to W15 are generated by learning information about communication in each of the IoT devices 30A-1 to 30A-15. The generation unit 232 stores the generated individual whitelist in the storage unit 22.

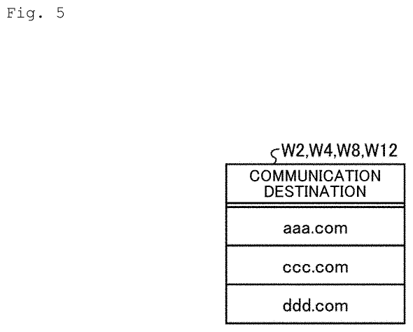

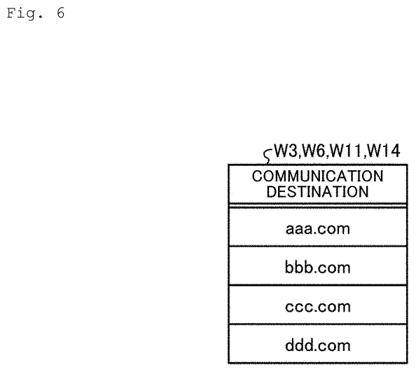

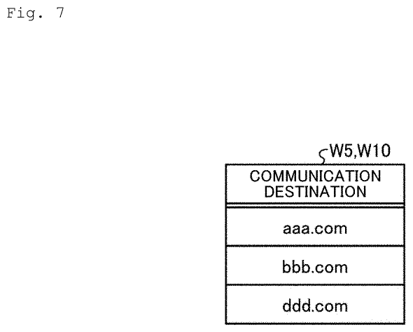

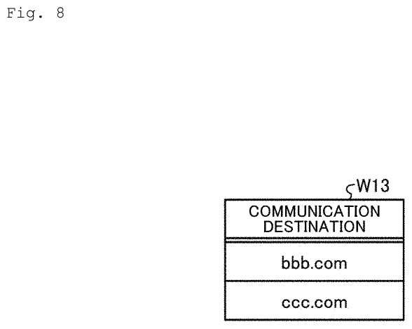

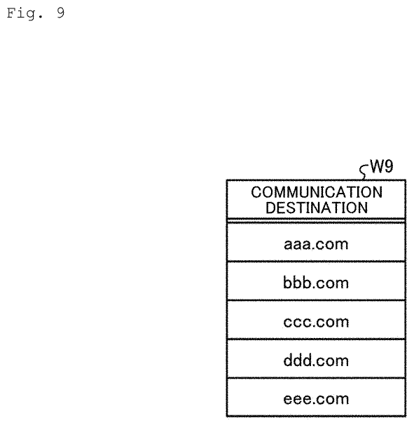

FIGS. 4 to 9 show an example of an individual whitelist generated by learning. FIG. 4 shows an example of individual whitelists W1, W7, W15, FIG. 5 shows an example of individual whitelists W2, W4, W8, W12, and FIG. 6 shows individual whitelists W3, W6, W11, W14, and an example is shown, FIG. 7 shows an example of the individual whitelists W5 and W10, FIG. 8 shows an example of the individual whitelist W13, and FIG. 9 shows an example of the individual whitelist W9.

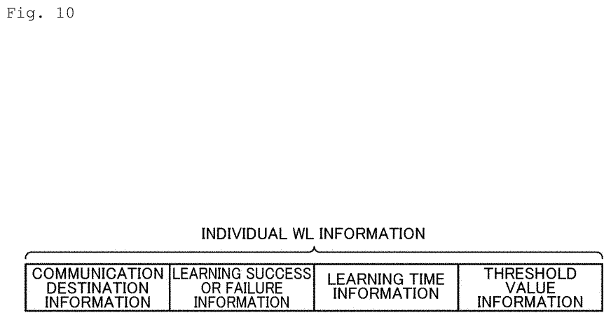

Further, the generation unit 232 generates the “individual WL information” shown in FIG. 10. In FIG. 10, the individual WL information includes “communication destination information”, “learning success or failure information”, “learning time information”, and “threshold information”. Further, the individual WL information includes an identifier (not shown) that can uniquely identify the management device 20 and a model name (not shown) of the IoT device connected to each management device 20. An example of an identifier that can uniquely identify the management device 20 (hereinafter, may be referred to as a “management device identifier”) is a serial number of the management device 20.

In the “communication destination information” in FIG. 10, information indicating the communication destination shown in the individual whitelist is stored by the generation unit 232. For example, the generation unit 232 that generated the individual whitelist W1, stores the three communication destinations of “aaa.com”, “bbb.com”, and “ccc.com” (FIG. 4), in the individual WL information as communication destination information. Further, for example, the generation unit 232 that generated the individual whitelist W9, stored five communication destinations of “aaa.com”, “bbb.com”, “ccc.com”, “ddd.com”, and “eee.com” (FIG. 9), in individual WL information as communication destination information. That is, there is a one-to-one correspondence between the contents of the individual whitelist and the contents of the communication destination information in the individual WL information.

Further, an information indicating the success or failure of learning when the generation unit 232 generates the individual whitelist, is stored in the “learning success or failure information” in FIG. 10, by the generation unit 232. For example, when learning is successful, the word “success” is stored, and when learning fails, the word “failure” is stored. Further, in the “learning time information” in FIG. 10, the learning time required for the generation unit 232 to generate the individual whitelist is stored.

Further, the threshold value used in the update unit 233 is stored in the “threshold value” in FIG. 10. The update unit 233 will be described later.

Each upload unit 234 of the management devices 20-1 to 20-15 uploads the individual whitelists W1 to W15 to the server device 10, respectively, by transmitting the individual WL information shown in FIG. 10 to the server device 10 by using the communication unit 21.

In the server device 10 (FIG. 2), the collection unit 131 collects individual whitelists W1 to W15 uploaded from each of 20-15 by receiving the individual WL information uploaded from each of the management devices 20-1 to 20-15 by using the communication unit 11, and thus the management devices 20-1 to 20-1 to 20-15.

The aggregation unit 132 refers to the individual WL information uploaded from each of the management devices 20-1 to 20-15, and generates an “aggregated whitelist” which is the aggregation result of the individual whitelists W1 to W15.

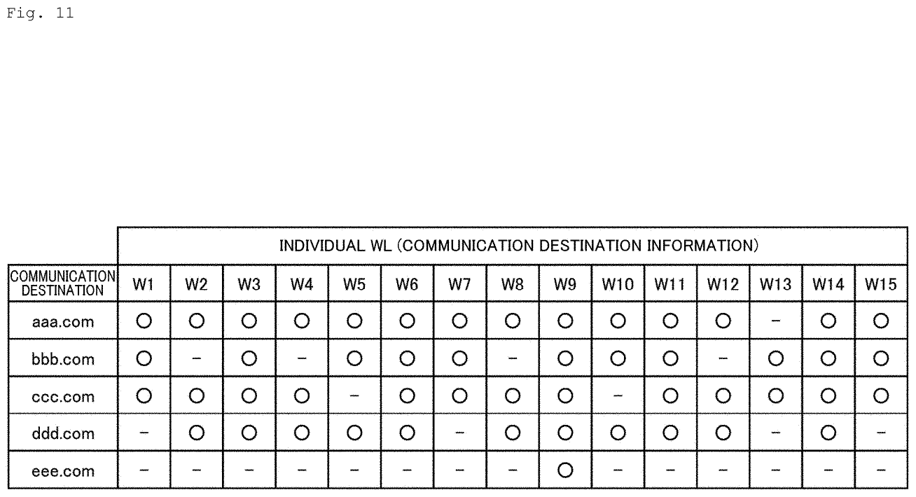

For example, the aggregation unit 132 refers to the communication destination information (FIG. 10) of the individual WL information uploaded from each of the management devices 20-1 to 20-15, and as shown in FIG. 11, refers to the individual whitelists W1 to W15, and generates a list of communication destinations (that is, authorized communication destinations) shown in each of the above (hereinafter, may be referred to as an “authorized communication destination list”). In the list of authorized communication destinations, authorized communication destinations are shown for each of the individual whitelists W1 to W15. In FIG. 11, the communication destination corresponding to the “0” mark is the communication destination shown in the individual whitelist, and the communication destination corresponding to the “-” mark is the communication destination not shown in the individual whitelist. Therefore, the individual whitelists W1 to W15 (FIGS. 4 to 9) and the list of authorized communication destinations (FIG. 11) have a one-to-one correspondence.

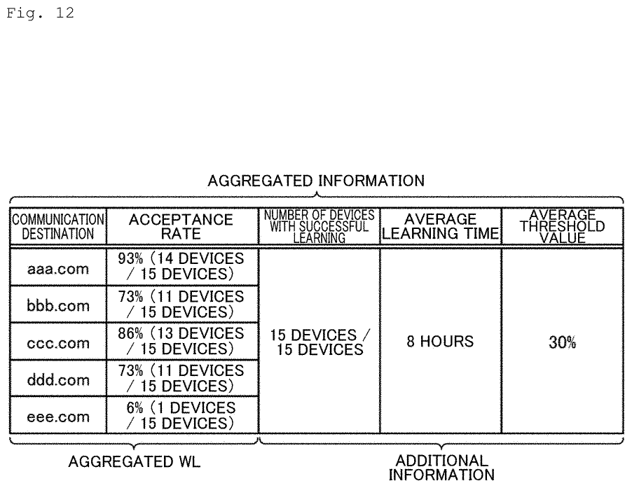

The aggregation unit 132 generates the “aggregated information” shown in FIG. 12 based on the list of authorized communication destinations (FIG. 11). In FIG. 12, the aggregated information includes an “aggregated whitelist” and “additional information”. The additional information includes “successful learning number”, “average learning time”, and “average threshold value”. The aggregation unit 132 calculates the acceptance rate for each of the fifteen management devices 20 of the management devices 20-1 to 20-15 for each communication destination shown in the list of authorized communication destinations, and stores the correspondence of each communication destination and the acceptance rate as an “aggregated whitelist” in the aggregated information. That is, the aggregated whitelist is the aggregated result of the individual whitelists W1 to W15.

For example, the communication destination aaa.com shown in the list of authorized communication destinations (FIG. 11) is adopted as an authorized communication destination by 14 out of 15 management devices 20, so that the acceptance rate of the communication destination aaa.com is 93% in the aggregated whitelist (FIG. 12). Further, for example, the communication destination bbb.com shown in the list of authorized communication destinations is adopted as an authorized communication destination by 11 out of 15 management devices 20, so that the acceptance rate of the communication destination bbb.com is 73% in the aggregated whitelist. Further, for example, the communication destination ccc.com shown in the list of authorized communication destinations is adopted as an authorized communication destination by 13 out of 15 management devices 20, so that the acceptance rate of the communication destination ccc.com is 86% in the aggregated whitelist. Further, for example, the communication destination ddd.com shown in the list of authorized communication destinations is adopted as an authorized communication destination by 11 out of 15 management devices 20, so that the acceptance rate of the communication destination ddd.com is 73% in the aggregated whitelist. Further, for example, the communication destination eee.com shown in the list of authorized communication destinations is adopted as an authorized communication destination by one out of 15 management devices 20, so that the acceptance rate of the communication destination eee.com is 6% in the aggregated whitelist.

Here, since the authorized communication destination in the IoT device 30A is the communication destination registered in the individual whitelist, it corresponds to the communication destination permitted to communicate with the IoT device 30A by the management device 20. Therefore, the acceptance rate corresponding to each communication destination in the aggregated whitelist corresponds to the rate of the number of management devices 20 that permits to communicate with the communication destination to the total number of the plurality of management devices 20.

Further, the aggregation unit 132 refers to the learning success or failure information (FIG. 10) of the individual WL information uploaded from each of the management devices 20-1 to 20-15, and totals the number of successfully learned management devices 20 in the management device 20 of the fifteen management devices 20-1 to 20-15, and the totaled result is stored in the aggregated information as the “successful learning number”.

Further, the aggregation unit 132 refers to the learning time information (FIG. 10) of the individual WL information uploaded from each of the management devices 20-1 to 20-15, and, the average value of learning time of the fifteen management devices 20-1 to 20-15 is calculated, and the average value of learning time is stored in the aggregated information as “average learning time”.

Further, the aggregation unit 132 refers to the threshold information (FIG. 10) of the individual WL information uploaded from each of the management devices 20-1 to 20-15, and calculates the average value of the threshold values of the fifteen management devices 20-1 to 20-15, and the average value of the threshold value is stored in the aggregated information as the “average threshold value”.

As described above, the aggregation unit 132 generates the aggregated information shown in FIG. 12, and stores the generated aggregated information in the storage unit 12.

The distribution unit 133 transmits the aggregated information generated as described above to each of the management devices 20-1 to 20-15 by using the communication unit 11, thereby transmitting the aggregated information to the management devices 20-1 to 20-15, and distribute to 15. By distributing the aggregated information, the aggregated whitelist is distributed to each of the management devices 20-1 to 20-15.

In the management device 20 (FIG. 3), the acquisition unit 231 acquires the aggregated whitelist distributed from the server device 10 by receiving the aggregated information distributed from the server device 10 by using the communication unit 21.

The update unit 233 updates the individual whitelist based on the aggregated whitelist generated by the generation unit 232 and stored in the storage unit 22.

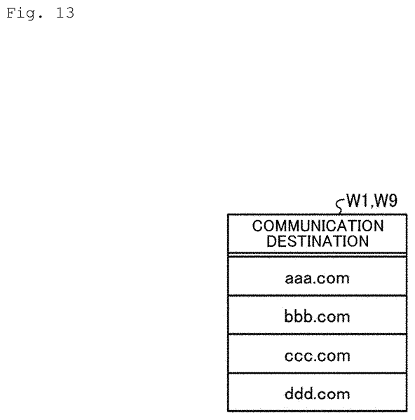

For example, when “10%” is stored as a threshold value in the storage unit 22 of the management device 20-1, the update unit 233 of the management device 20-1, and a threshold value of 10% is applied to an aggregated whitelist (FIG. 12) acquired by the acquisition unit 231, and the applied threshold value is output to the generation unit 232. Among the communication destinations aaa.com, bbb.com, ccc.com, ddd.com, eee.com in the aggregated whitelist (FIG. 12), the communication destinations with an acceptance rate of 10% or more are aaa.com, bbb.com, ccc.com, ddd.com, and the communication destination with the acceptance rate of less than 10% is eee.com. In addition, while the communication destinations with an acceptance rate of 10% or more in the aggregated whitelist are aaa.com, bbb.com, ccc.com, and ddd.com, the communication destinations already registered in the individual whitelist W1 (FIG. 4) are aaa.com, bbb.com, and ccc.com. Therefore, the update unit 233 of the management device 20-1 updates the individual whitelist W1 by adding ddd.com as a communication destination in the individual whitelist W1. Therefore, the updated individual whitelist W1 is as shown in FIG. 13.

For example, when “10%” is stored as a threshold value in the storage unit 22 of the management device 20-9, the update unit 233 of the management device 20-9, and a threshold value of 10% is applied to an aggregated whitelist (FIG. 12) acquired by the acquisition unit 231, and the applied threshold value is output to the generation unit 232. Among the communication destinations aaa.com, bbb.com, ccc.com, ddd.com, eee.com in the aggregated whitelist (FIG. 12), the communication destinations with an acceptance rate of 10% or more are aaa.com, bbb.com, ccc.com, ddd.com, and the communication destination with the acceptance rate of less than 10% is eee.com. In addition, while the communication destinations with an acceptance rate of 10% or less in the aggregated whitelist is eee.com, the communication destinations already registered in the individual whitelist W9 (FIG. 9) are aaa.com, bbb.com, ccc.com, ddd.com and eee.com. Therefore, the update unit 233 of the management device 20-9 updates the individual whitelist W9 by deleting eee.com from the communication destinations in the individual whitelist W9. Therefore, the updated individual whitelist W9 is as shown in FIG. 13.

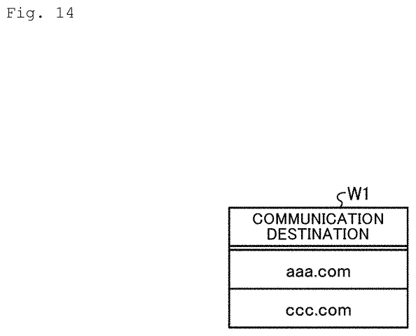

Further, for example, when “80%” is stored as a threshold value in the storage unit 22 of the management device 20-1, the update unit 233 of the management device 20-1, and a threshold value of 80% is applied to an aggregated whitelist (FIG. 12) acquired by the acquisition unit 231, and the applied threshold value is output to the generation unit 232. Among the communication destinations aaa.com, bbb.com, ccc.com, ddd.com, eee.com in the aggregated whitelist (FIG. 12), the communication destinations with an acceptance rate of 80% or more are aaa.com and ccc.com, and the communication destination with the acceptance rate of less than 80% is bbb.com, ddd.com, and eee.com. In addition, while the communication destinations with an acceptance rate of 80% or less in the aggregated whitelist are bbb.com, ddd.com, and eee.com, the communication destinations already registered in the individual whitelist W1 (FIG. 4) are aaa.com, bbb.com, and ccc.com. Therefore, the update unit 233 of the management device 20-1 updates the individual whitelist W1 by deleting bbb.com from the communication destinations in the individual whitelist W1. Therefore, the updated individual whitelist W1 is as shown in FIG. 14.

As described above, the update unit 233 updates the individual whitelist by adding the communication destinations whose acceptance rate in the aggregated whitelist is equal to or higher than the threshold value to the individual whitelist. Further, the update unit 233 updates the individual whitelist by deleting the communication destinations whose acceptance rate in the aggregated whitelist is less than the threshold value from the individual whitelist.

The individual whitelist after the update is stored in the storage unit 22. The detection unit 235 detects unauthorized communication in the IoT device 30A by using the updated individual whitelist stored in the storage unit 22.

When the individual whitelist is updated by the update unit 233, the generation unit 232 generates individual WL information including the communication destination shown in the updated individual whitelist as the communication destination information, and the upload unit 234 uploads the generated individual WL information to the server device 10. Then, the aggregation unit 132 of the server device 10 updates the aggregation information based on the uploaded individual WL information.

It is also possible for the user of the management device 20 to manually update the individual whitelist by comparing the individual whitelist with the aggregated whitelist.

The embodiment 1 has been described above.

### Embodiment 2

In the embodiment 2, a case where communication with a communication destination not registered in the individual whitelist (hereinafter, may be referred to as a “new communication destination”) is detected will be described.

<Operation of Communication Network System>

When the acquisition unit 231 detects communication with a new communication destination, the acquisition unit 21 uses the communication unit 21 to make an acquisition request for an aggregated whitelist (hereinafter, may be referred to as an “aggregated WL request”), and sends it to the server device 10.

The distribution unit 133 individually transmits the aggregated information stored in the storage unit 12 in response to the aggregated WL request to the management device 20 of the transmission source of the aggregated WL request, that is, the management device 20 in which communication with the new communication destination is detected, using the communication unit 11.

The update unit 233 updates an individual whitelist stored in the storage unit 22 based on the aggregated whitelist transmitted from the server device 10 in response to the aggregated WL request, and included in the aggregated information acquired by the acquisition unit 231.

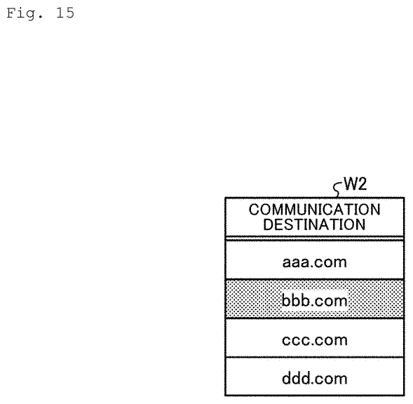

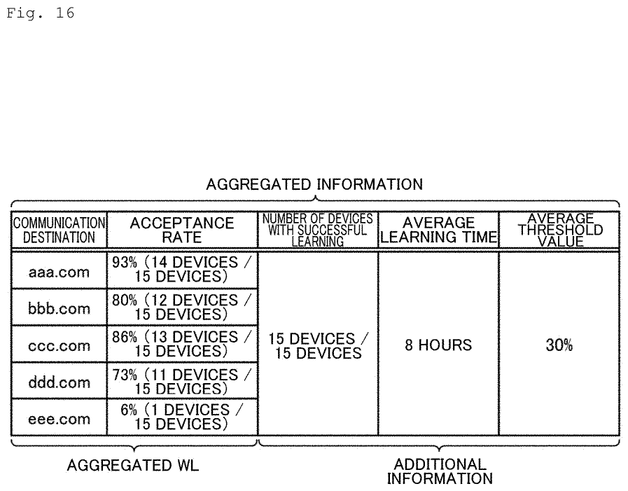

FIG. 15 and FIG. 16 are diagrams for explaining an operation example of the communication network system of the embodiment 2 of the present disclosure.

For example, when the individual whitelist before the update in the management device 20-2 is the individual whitelist W2 shown in FIG. 15, when the management device 20-2 detects the communication with communication destination bbb.com, the acquisition unit 231 of the management device 20-2 transmits the aggregated WL request to the server device 10, since the destination bbb.com is a communication destination not registered in the individual whitelist W2 (FIG. 5).

In response to the aggregation WL request from the management device 20-2, the distribution unit 133 individually transmits the aggregation information (FIG. 12) stored in the storage unit 12 to the management device 20-2.

The update unit 233 of the management device 20-2 updates the individual whitelist W2 shown in FIG. 15 based on the aggregated whitelist included in the aggregated information (FIG. 12). For example, when “30%” is stored as a threshold value in the storage unit 22 of the management device 20-2, the update unit 233 of the management device 20-2 applies a threshold of 30% to an aggregated whitelist (FIG. 12) acquired by the acquisition unit 231. In the aggregated whitelist (FIG. 12), among the communication destinations aaa.com, bbb.com, ccc.com, ddd.com, and eee.com, the communication destinations with an acceptance rate of 30% or more are aaa.com, bbb.com, ccc.com, ddd.com, and the communication destination with the acceptance rate of less than 30% is eee.com. In addition, while the communication destinations with an acceptance rate of 30% or more in the aggregated whitelist (FIG. 12) are aaa.com, bbb.com, ccc.com, and ddd.com, the individual whitelist W2 (FIG. 15), the communication destinations registered in are aaa.com, ccc.com, and ddd.com. Therefore, the update unit 233 of the management device 20-2 updates the individual whitelist W2 by adding bbb.com as a communication destination in the individual whitelist W2. Therefore, the updated individual whitelist W2 is as shown in FIG. 15.

Further, the generation unit 232 of the management device 20-2 generates individual WL information including the communication destination shown in the updated individual whitelist W2 (FIG. 15) as the communication destination information, and the upload unit 234 generates the individual WL information, and then the individual WL information is uploaded to the server device 10.

The aggregation unit 132 of the server device 10 updates the aggregation information based on the uploaded individual WL information. Therefore, in the aggregated information after the update (FIG. 16), the acceptance rate corresponding to the communication destination bbb.com increases from 73% to 80% as compared with the aggregated information before the update (FIG. 12).

The embodiment 2 has been described above.

### Embodiment 3

In the embodiment 3, a case where a new IoT device 30 is connected to the communication network system 1 will be described.

<Operation of Communication Network System>

For example, with respect to FIG. 1, a new IoT device 30A-16 (not shown) is connected to the network 40 via a new management device 20-16 (not shown). The IoT device 30A-16 is an IoT device of the same model as the IoT devices 30A-1 to 30A-15.

When the acquisition unit 231 of the management device 20-16 detects the connection of the IoT device 30A-16 to the management device 20-16, the acquisition unit 231 transmits the aggregated WL request to the server device 10 by using the communication unit 21 after a predetermined time has elapsed from the detection of the connection of the IoT device 30A-16. The predetermined time from the detection of the connection of the IoT device 30A-16 to the transmission of the aggregate WL request is preset to, for example, the time until the generation of the first individual whitelist in the generation unit 232 of the management device 20-16 is completed after the connection of the IoT device 30A-16 is detected.

The distribution unit 133 individually transmits the aggregated information stored in the storage unit 12 to the management device 20-16 of the transmission sources of the aggregated WL request, that is, the management device 20, in which the connection of the new IoT device 30 is detected, by using the communication unit 11, in response to the aggregated WL request.

The update unit 233 of the management device 20-16 is stored in the storage unit 22 based on the aggregated whitelist transmitted from the server device 10 in response to the aggregated WL request and included in the aggregated information acquired by the acquisition unit 231 to update the individual whitelist that has been done.

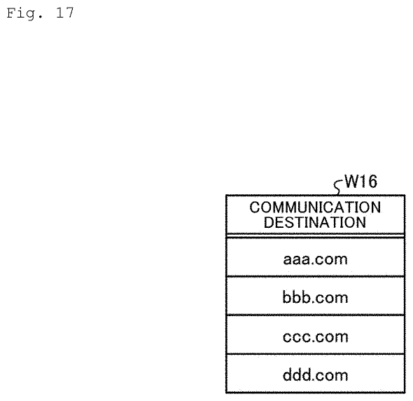

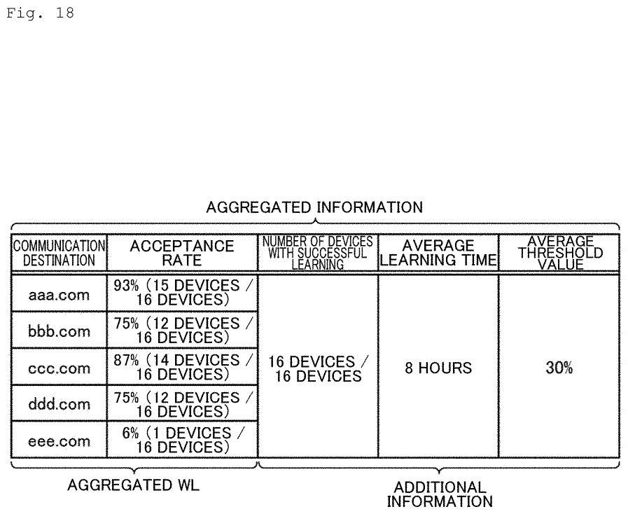

FIG. 17 and FIG. 18 are diagrams for explaining an operation example of the communication network system of the embodiment 3 of the present disclosure.

For example, when the individual whitelist before the update in the management device 20-16 is the individual whitelist W16 shown in FIG. 17, the acquisition unit 231 of the management device 20-16 transmits the aggregated WL request to the server device 10.

In response to the aggregation WL request from the management device 20-16, the distribution unit 133 individually transmits the aggregation information (FIG. 12) stored in the storage unit 12 to the management device 20-16.

The update unit 233 of the management device 20-16 updates the individual whitelist W16 shown in FIG. 17 based on the aggregated whitelist included in the aggregated information (FIG. 12). For example, when “50%” is stored as a threshold value in the storage unit 22 of the management device 20-16, the update unit 233 of the management device 20-16 applies threshold of 50% to the aggregated whitelist (FIG. 12) acquired by the acquisition unit 231. Among the communication destinations aaa.com, bbb.com, ccc.com, ddd.com, and eee.com in the aggregated whitelist (FIG. 12), the communication destinations with an acceptance rate of 50% or more are aaa.com, bbb.com, ccc.com, and ddd.com, and the communication destination with the acceptance rate of less than 50% is eee.com. In addition, while the communication destinations with an acceptance rate of 50% or more in the aggregated whitelist (FIG. 12) are aaa.com, bbb.com, ccc.com, and ddd.com, the communication destinations registered in the individual whitelist W16 (FIG. 17) are also the same for aaa.com, bbb.com, ccc.com, and ddd.com. Therefore, the update unit 233 of the management device 20-16 maintains the state shown in FIG. 17 without adding or deleting the communication destination in the individual whitelist W16.

Further, the generation unit 232 of the management device 20-16 generates individual WL information including the communication destination shown in the individual whitelist W16 (FIG. 17) as the communication destination information, and the upload unit 234 uploads the generated individual WL information to the server device 10.

The aggregation unit 132 of the server device 10 updates the aggregation information based on the uploaded individual WL information. Therefore, in the aggregated information after the update (FIG. 18), the total number of management devices 20 in the acceptance rate is updated from 15 to 16 as compared with the aggregated information before the update (FIG. 12). Further, as the total number of management devices 20 is updated from 15 to 16 about the acceptance rate, the acceptance rate of each communication destination is recalculated.

The embodiment 3 has been described above.

### Embodiment 4

<Operation of Communication Network System>

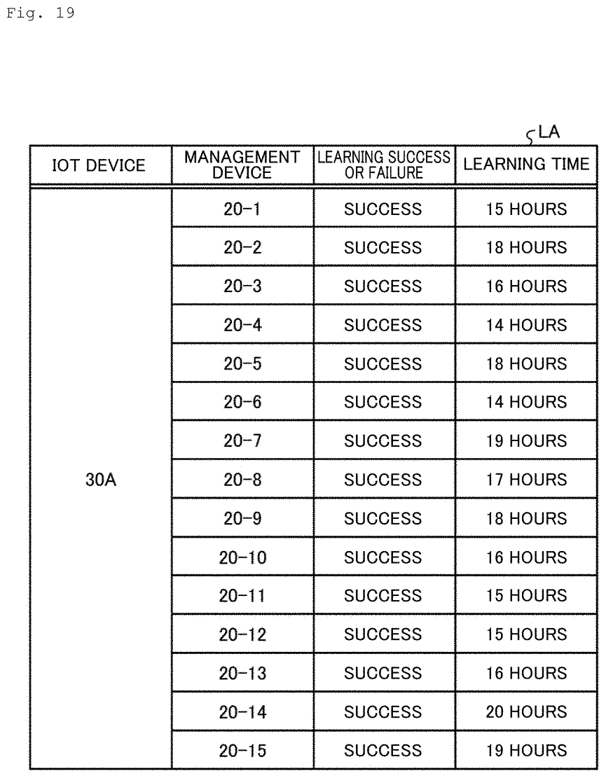

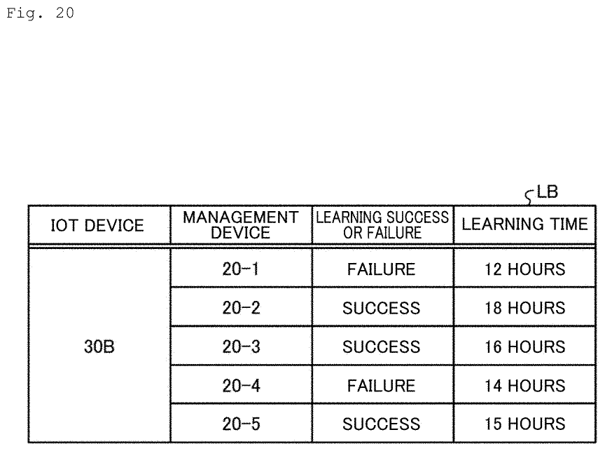

FIG. 19 and FIG. 20 are diagrams for explaining an operation example of the communication network system of the embodiment 4 of the present disclosure.

As described above, the individual WL information transmitted from each management device 20 to the server device 10 includes the model name of the IoT device, the management device identifier, the learning success or failure information, and the learning time information.

Therefore, the aggregation unit 132 of the server device 10 generates the information summarizing the learning success or failure and the learning time of the individual whitelist in each management device 20 for each model of the IoT device (hereinafter, referred to as “learning information”).

FIG. 19 and FIG. 20 show an example of the learning information. FIG. 19 shows an example of learning information about an IoT device (that is, “IoT device 30A”) having a model name of “30A”, and FIG. 20 shows an example of learning information about an IoT device having a model name of “30B” (that is, “IoT” device “30B”). Further, in FIGS. 19 and 20, two IoT devices, an IoT device 30A and an IoT device 30B, are connected to the management devices 20-1 to 20-5, respectively, and the management devices 20-6 to 20-15, respectively, and the case where one IoT device 30A is connected to be shown.

For example, the learning information LA (FIG. 19) shows that the learning of the individual whitelist is successful in all the management devices 20-1 to 20-15 to which the IoT device 30A is connected.

Further, for example, in the learning information LB (FIG. 20), among the management devices 20-1 to 20-5 to which the IoT device 30B is connected, the learning of the individual whitelist has succussed in the management devices 20-2, 20-3, 20-5, on the other hand, it is shown that the learning of the individual whitelist has failed in the management devices 20-1 and 20-4. Further, since in the learning information LB, the learning succeeds when the learning time is 15 hours or more, and the learning fails when the learning time is 14 hours or less, it is estimated from the learning information LB that 15 hours or more of learning time is required for successful learning of the individual whitelist applied to the IoT device 30B.

By transmitting the learning information LA (FIG. 19) and the learning information LB (FIG. 20) to each of the management devices 20-1 to 20-15 by using the communication unit 11 by the providing unit 134 of the server device 10, the learning information LA and LB are provided to the management devices 20-1 to 20-15.

By receiving the learning information LA and LB provided by the server device 10 by using the communication unit 21, the acquisition unit 231 of the management device 20 acquires the learning information LA and LB provided by the server device 10. The acquisition unit 231 stores the acquired the learning information LA and LB in the storage unit 22.

The embodiment 4 has been described above.

### Embodiment 5

<Operation of Communication Network System>

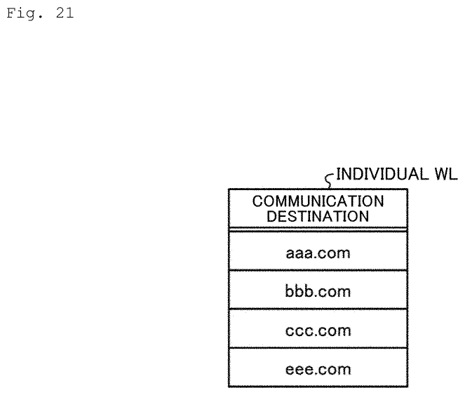

FIGS. 21, 22 and 23 are diagrams provided for explaining an operation example of the communication network system of embodiment 5 of the present disclosure.

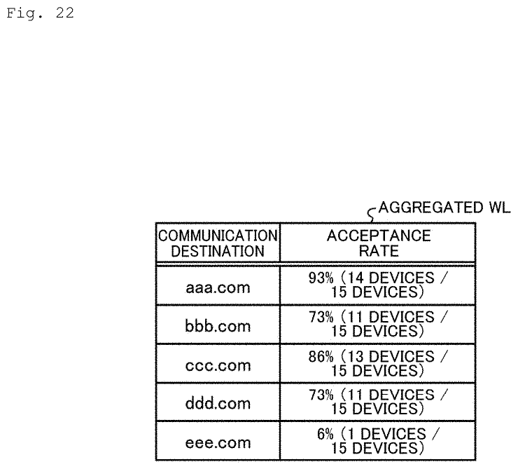

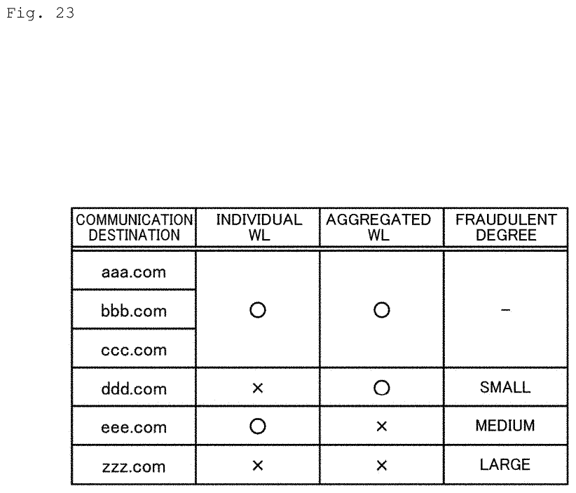

The detection unit 235 of the management device 20 generates an “unauthorized communication detection list” indicating the degree of fraud of each communication destination based on the comparison result between the individual whitelist and the aggregated whitelist. For example, in the management device 20, when the individual whitelist stored in the storage unit 22 is shown in FIG. 21, and the aggregated whitelist acquired by the acquisition unit 231 is shown in FIG. 22, the detection unit 235 generates the unauthorized communication detection list shown in FIG. 23 by comparing the individual whitelist and the aggregated whitelist. The detection unit 235 stores the generated unauthorized communication detection list in the storage unit 22.

In the comparison between FIG. 21 and FIG. 22, the communication destinations aaa.com, bbb.com, and ccc.com exist in both the individual whitelist and the aggregated whitelist. In addition, the communication destination ddd.com does not exist in the individual whitelist, but exists in the aggregated whitelist. In addition, the communication destination eee.com exists in the individual whitelist, but does not exist in the aggregated whitelist. In addition, the communication destination zzz.com does not exist in both the individual whitelist and the aggregated whitelist. Therefore, the detection unit 235 sets up the fraudulent degree for the communication destinations aaa.com, bbb.com, and ccc.com to “-” indicating an authorized communication destination in the unauthorized communication detection list (FIG. 23), and sets up the communication destination to “-”, and then sets up the fraudulent degree for ddd.com to “small”, sets up the fraudulent degree for the communication destination eee.com to “medium”, and sets up the fraudulent degree for the communication destination zzz.com to “large”.

Further, the detection unit 235 determines the degree of fraud of the communication destination in which the communication has occurred by referring to the unauthorized communication detection list (FIG. 23) when the communication with the communication destination occurs.

The embodiment 5 has been described above.

### Embodiment 6

<Processing Procedure in Communication Network System>

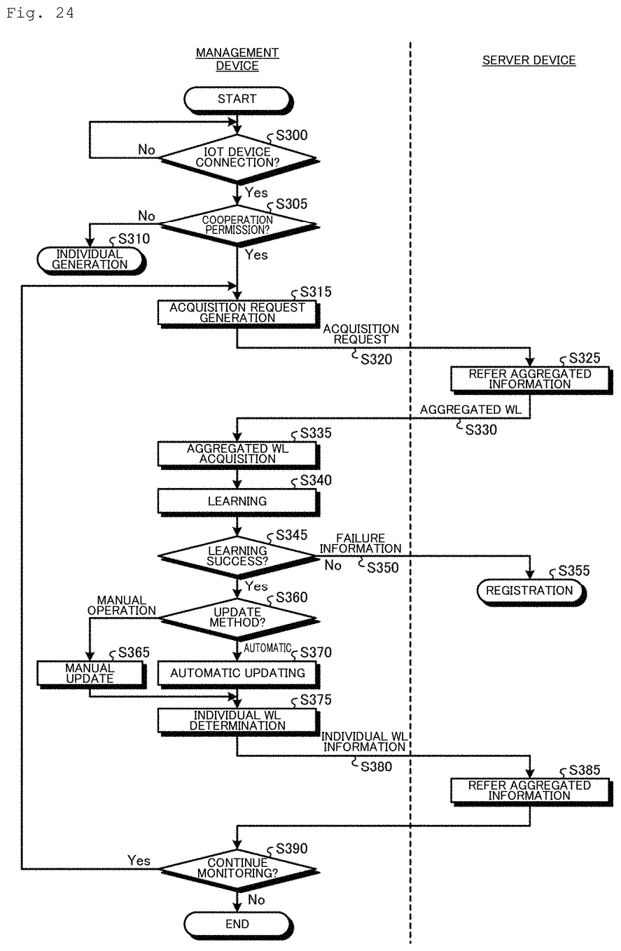

FIG. 24 is a flowchart showing an example of the processing procedure in the communication network system of the embodiment 6 of the present disclosure.

In FIG. 24, in step S300, the acquisition unit 231 waits until the IoT device is connected to the own device (step S300: No), and when the IoT device is connected to the management device 20 (step S300: Yes), and then the process proceeds to step S305.

In step S305, the acquisition unit 231 determines whether or not the management device 20 is permitted to cooperate with the server device 10. When cooperation is not permitted (step S305: No), the management device 20 independently generates an individual whitelist without using the aggregated whitelist (step S310).

When cooperation with the server device 10 is permitted (step S305: Yes), the acquisition unit 231 generates an aggregation whitelist acquisition request (step S315), and transmits the generated acquisition request to the server device 10 (Step S320).

In response to the acquisition request from the management device 20, the distribution unit 133 refers to the aggregated information stored in the storage unit 12 (step S325) and distributes the aggregated whitelist to the management device 20 (step S330).

In step S335, the acquisition unit 231 acquires the aggregated whitelist distributed from the server device 10.

In step S340, the generation unit 232 generates an individual whitelist by learning, and stores the generated individual whitelist in the storage unit 22.

In step S345, the generation unit 232 determines whether or not the individual whitelist has been successfully learned. When the learning of the individual whitelist fails (step S345: No), the generation unit 232 transmits “failure information” indicating that the learning has failed to the server device 10 (step S350), and the collection unit 131 registers the failure information in the storage unit 12 (step S355).

On the other hand, when the learning of the individual whitelist is successful (step S345: Yes), the update unit 233 confirms the predefined update method (step S360). When the predefined update method is “manual”, the update unit 233 does not update the individual whitelist, and the user of the management device 20 manually updates the individual whitelist (step S365). On the other hand, when the predefined update method is “automatic”, the update unit 233 automatically updates the individual whitelist stored in the storage unit 22 based on the aggregated whitelist (step S370). The individual whitelist is determined by the process of step S365 or step S70 (step S375).

After the individual whitelist is fixed, the upload unit 234 uploads the individual WL information to the server device 10 (step S380), and the aggregation unit 132 updates the aggregated information based on the individual WL information collected by the collection unit 131 (Step S385).

Further, in the management device 20, after transmitting the individual WL information, the detection unit 235 determines whether or not to continue monitoring the unauthorized communication (step S390). Whether or not to continue monitoring unauthorized communication is specified by, for example, the user of the management device 20. When the monitoring of unauthorized communication is continued (step S390: Yes), the process returns to step S315, and when the monitoring of unauthorized communication is stopped (step S390: No), the processing procedure ends.

The embodiment 6 has been described above.

### Embodiment 7

All or part of each process in the above description related to the control unit 13 may be realized by causing the control unit 13 to execute a program corresponding to each process. For example, a program corresponding to each process in the control unit 13 in the above description may be stored in the storage unit 12, and the program may be read out from the storage unit 12 by the control unit 13 and executed. Further, the program is stored in a program server connected to the server device 10 via an arbitrary network, downloaded from the program server to the server device 10 and executed, or stored in a recording medium readable by the server device 10, and then it may be read from the recording medium and executed. The recording medium that can be read by the server device 10 includes, for example, a memory card, a USB memory, an SD card, a flexible disk, a magneto-optical disk, a CD-ROM, a DVD, a Blu-ray (registered trademark) disk, and storage medium are included.

Further, all or part of each process in the above description in the control unit 23 may be realized by causing the control unit 23 to execute a program corresponding to each process. For example, a program corresponding to each process in the control unit 23 in the above description may be stored in the storage unit 22, and the program may be read out from the storage unit 22 by the control unit 23 and executed. Further, the program is stored in a program server connected to the management device 20 via an arbitrary network, downloaded from the program server to the management device 20 and executed, or stored in a recording medium readable by the management device 20, or it may be read from the recording medium and executed. The recording medium that can be read by the management device 20 includes, for example, a memory card, a USB memory, an SD card, a flexible disk, a magneto-optical disk, a CD-ROM, a DVD, and a Blu-ray (registered trademark) disk, and portable storage medium is included.

Further, the program is a data processing method described in an arbitrary language or an arbitrary description method, and may be in any format such as source code or binary code. In addition, the program is not necessarily limited to a single configuration program, but includes distributed configuration as multiple modules or multiple libraries, or cooperates with a separate program represented by the OS to achieve its function.

The embodiment 7 has been described above.

As described above, the communication network system of the present disclosure (communication network system 1 of the embodiment) is connected to the server device (server device 10 of the embodiment) and a plurality of IoT devices (IoT device 30A of the embodiment), respectively, or it also has a plurality of management devices (management device 20 of the embodiment). Each of the plurality of management devices is an individual whitelist individually generated in each of the plurality of management devices, and an individual whitelist relating to the communication destination of the IoT device connected to the own management device is generated, and then upload the generated individual whitelist to the server device. The server device collects a plurality of individual whitelists uploaded from each of the plurality of management devices, generates an aggregated whitelist that is the aggregated result of the plurality of individual whitelists, and distributes the generated aggregated whitelist to each of the plurality of management devices. Then, each of the plurality of management devices acquires the aggregated whitelist distributed from the server device, and updates the individual whitelist generated by the own management device based on the aggregated whitelist.

Further, the server device (server device 10 of the embodiment) of the present disclosure communicates with a plurality of management devices connected to each of a plurality of IoT devices, respectively, and has a collection unit (collection unit 131 of the embodiment), an aggregation unit (aggregation unit 132 of the embodiment), and a distribution unit (distribution unit 133 of the embodiment). The collection unit collects an individual whitelist generated separately for each of the plurality of management devices, and an individual whitelist related to the communication destination of the IoT device connected to each of the plurality of management devices from each of the plurality of management devices. The aggregation unit generates an aggregation whitelist which is the aggregation result of a plurality of collected individual whitelists. The distribution unit distributes the generated aggregated whitelist to each of the plurality of management devices.

Further, the management device (management device 20 of the embodiment) of the present disclosure is one of a plurality of management devices connected to a plurality of IoT devices, respectively, and includes a generation unit (generation unit 232 of the embodiment), an upload unit (upload unit 234 of the embodiment), an acquisition unit (acquisition unit 231 of the embodiment), and an update unit (update unit 233 of the embodiment). The generation unit is an individual whitelist generated separately from other management devices, and generates an individual whitelist regarding the communication destination of the IoT device connected to the own management device. The upload unit uploads the generated individual whitelist to the server device. The acquisition unit is an aggregated whitelist that is the aggregated result of a plurality of individual whitelists uploaded from each of the plurality of management devices, and acquires the aggregated whitelist generated in the server device from the server device. The update unit updates the individual whitelist based on the acquired aggregated whitelist.

For example, the aggregated whitelist includes the rate of the number of management devices that are permitted to communicate with the communication destination (the acceptance rate of the embodiment) to the total number of the plurality of management devices for each of the plurality of communication destinations. The update unit updates the individual whitelist by adding the communication destinations, where the rate is equal to or higher than the threshold value, to the individual whitelist. In addition, the update unit updates the individual whitelist by deleting the communication destinations whose rate is less than the threshold value from the individual whitelist.

In this way, by updating the individual whitelist based on the aggregated result of the plurality of individual whitelists individually generated by each of the plurality of management devices, the validity of the whitelist used for detecting unauthorized communication in each management device can be increased. By increasing the validity of the whitelist used for detecting fraudulent communication, over-detection and false detection of fraudulent communication are reduced, so that the detection accuracy of fraudulent communication is improved.

Further, when the acquisition unit detects communication with a new communication destination, the acquisition unit sends an acquisition request for the aggregated whitelist to the server device. The distribution unit individually transmits the aggregated whitelist to the management device in response to the acquisition request from the management device in which communication with a communication destination not registered in the individual whitelist is detected. The update unit updates the individual whitelist based on the aggregated whitelist acquired from the server device in response to the acquisition request.

By doing so, since the individual whitelist can be updated immediately when a new communication destination appears, determination can be immediately performed whether the new communication destination is an authorized communication destination or not when the new communication destination appears.

Further, the server device has a providing unit (providing unit 134 of the embodiment). The providing unit 134 provides information on the success or failure of learning of the individual whitelist and information on the learning time of the individual whitelist to a plurality of management devices.

By doing so, the user of the management device can estimate the learning time until the individual whitelist generated by learning can be used for detecting unauthorized communication.

### REFERENCE SIGNS LIST

1 Communication network system
10 Server device
20 Management device
30A IoT device
13, 23 Control unit
131 Collection unit
132 Aggregation unit
133 Distribution unit
134 Providing unit
231 Acquisition unit
232 Generation unit
233 Update unit
234 Upload unit
235 Detection unit

1. A communication network system, comprising:
a server; and
a plurality of computers to manage respectively connected to a plurality of IoT (“Internet of Things”) devices,
wherein:
each of the plurality of computers to manage generates the individual whitelist, which is individually generated in each of the plurality of computers to manage, and is related to a communication destination of an IoT device connected to an own management device, and uploads the generated individual whitelist to the server,
the server collects the plurality of individual whitelists uploaded from each of the plurality of computers to manage, generates an aggregated whitelist that is an aggregated result of the plurality of individual whitelists, and distributes the generated aggregated whitelist to each of the plurality of computers to manage, and
each of the plurality of computers to manage acquires the aggregated whitelist distributed from the server, and updates the individual whitelist generated by an own management device based on the aggregated whitelist.

2. A management device, which is one of a plurality of computers to manage connected to each of a plurality of IoT devices, a management device, comprising:
generation circuitry for generating the individual whitelist which is separately generated in other computers to manage, and is related to a communication destination of an IoT device connected to an own management device,
upload circuitry of uploading the generated individual whitelist to a server;
acquisition circuitry that acquires an aggregated whitelist, which is an aggregated result of the plurality of individual whitelists uploaded from each of the plurality of computers to manage, and is generated in the server, from the server; and
update circuitry that updates the individual whitelist based on acquired the aggregated whitelist.

3. The management device according to claim 2, wherein:
the aggregated whitelist includes the rate of the number of computers to manage that are permitted to communicate with the communication destination to the total number of the plurality of computers to manage for each of the plurality of communication destinations, and
the update circuitry updates the individual whitelist by adding the communication destinations, where the rate is equal to or higher than the threshold value, to the individual whitelist.

4. The management device according to claim 2, wherein:
the aggregated whitelist includes the rate of the number of computers to manage that are permitted to communicate with the communication destination to the total number of the plurality of computers to devices for each of the plurality of communication destinations, and
the update circuitry updates the individual whitelist by deleting a communication destination whose rate is less than the threshold value from the individual whitelist.

5. The management device according to claim 2, wherein:
the acquisition circuitry sends an acquisition request for the aggregated whitelist to the server, when the acquisition circuitry detects communication with a communication destination not registered in the individual whitelist, and
the update circuitry updates the individual whitelist based on the aggregated whitelist acquired from the server in response to the acquisition request.

6. A server, which communicates with a plurality of computers to manage for connection to a plurality of IoT devices, the server comprising:
collection circuitry for collecting an individual whitelist which is separately generated for each of the plurality of computers to manage, and related to the communication destination of an IoT device connected to each of the plurality of computers to manage from each of the plurality of computers to manage;
aggregation circuitry that generates an aggregation whitelist which is an aggregation result of the plurality of collected individual whitelists; and
distribution circuitry that distributes the generated aggregated whitelist to each of the plurality of computers to manage.

7. The server according to claim 6, wherein:
the distribution circuitry individually transmits the aggregated whitelist to the management device in response to the acquisition request from the management device which detects a communication with a communication destination not registered in the individual whitelist.

8. The server according to claim 6, further comprising:
providing circuitry that provides information on the success or failure of learning of the individual whitelist and information on learning time of the individual whitelist with the plurality of computers to manage.

9-11. (canceled)
